(19) United States
(12) Patent Application Publication
(10) Pub. No.: US 2010/0225569 A1
(43) Pub. Date: Sep. 9, 2010

(54) LIQUID CRYSTAL DISPLAY, MANUFACTURING METHOD THE SAME, AND DRIVING METHOD THEREOF

(75) Inventors: Hong-Jo PARK, Suwon-si (KR); Hyeok-Jin LEE, Seonggnam-si (KR); Sung-Jae YUN, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/339,571

(22) Filed: Dec. 19, 2008

(51) Int. Cl. G09G 3/36; C09K 19/00

(52) U.S. Cl. 345/87; 430/20

(57) ABSTRACT

The blue phase mode may include a photo polymerizing process to sustain the blue phase molecule alignment at room temperature which is called polymer stabilized blue phase (PBP) mode. The blue phase mode LCD or the PBP mode LCD may have a hysteresis characteristic. The hysteresis can be reduced by driving the LCD using an impulsive method.

### BACKGROUND OF THE INVENTION

1. Field of the Invention

The present invention relates to a liquid crystal display (LCD), a manufacturing method of the LCD, and a driving method of the LCD.

2. Description of Related Art

An LCD device displays images using optical characteristics (i.e. refractive index anisotropy or birefringence) and electrical characteristics (i.e. dielectric anisotropy) of liquid crystal (LC) material. The LCD device has advantageous characteristics such as thinner thickness, lower driving voltage, lower power consumption, etc., than other types of display devices such as a cathode ray tube (CRT) device, a plasma display panel (PDP) device, and the like.

The LCD device includes an array substrate, an opposing substrate that is parallel to the array substrate, and a liquid crystal (LC) layer interposed between the array substrate and the opposing substrate. The array substrate includes a plurality of thin film transistors (TFTs).

A TFT has a gate electrode, a semiconductor pattern, a source electrode, and a drain electrode. The array substrate may include a pixel electrode, a gate signal line, and a data signal line. The array substrate is usually manufactured using a photolithography process. A plurality of photo-masks is used to make the array substrate. Some array substrates are made by 3 photo-masks. Some others are made by 4 or 5 photo-masks. When an array substrate is made by 3 or 4 photo-masks, a slit mask or a halftone mask is used.

The LC layer used in LCDs may include nematic LCs. The nematic LC molecules are usually aligned twisted nematic (TN) type, vertical alignment (VA) type, or in plane switching (IPS) type. The IPS type has a homogeneously aligned LC layer.

### SUMMARY OF THE INVENTION

This invention provides in one embodiment an LCD device that has fast response time and good image quality.

A manufacturing method and driving method of the LCD device is also provided.

In an embodiment of the invention an LCD includes, a first substrate which has pixel electrodes, a second substrate opposite the first substrate, an LC layer disposed between the first substrate and the second substrate, and a circuitry which transfers image signals and dummy signals to the pixel electrodes, wherein the dummy signals are applied to the pixel electrodes, the dummy signals are black signals or gray signals, and the LC layer comprises LC molecules and a polymer structure which stabilizes the liquid crystal molecules to the arrangement that the liquid crystal molecules are arranged at a temperature of about 1 degree C. below the Tₙᵢ of the liquid crystal.

This invention also provides an LCD comprising, a blue phase LC layer and a circuitry which transfers image signals and dummy signals to the pixel electrodes, wherein the dummy signals are applied to the pixel electrodes; the dummy signals are black signals or gray signals.

This invention also provides an LCD comprising, a blue phase LC layer and a circuitry which transfers an impulsive image signal to the pixel electrode of the LCD.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A shows a blue phase structure.

FIG. 1B shows the blue phase I structure and the blue phase II structure.

FIG. 1C shows an LC molecule alignment structure on temperature.

FIG. 2A shows a stabilizing structure of the blue phase with a polymer.

FIG. 2B shows a weak area of a blue phase LC.

FIG. 3 shows types of transmittance hysteresis curves versus applied voltage.

FIG. 4 shows voltage dependencies of the LC molecule alignment of the blue phase structure.

FIG. 5A shows voltage v. transmittance curves of a polymer stabilized blue phase (PBP) mode.

FIG. 5B is an exaggerated graph of the low voltage area in FIG. 5A from 0 volts to 10 volts.

FIG. 5C shows voltage v. transmittance curves of a 32″ blue phase mode LCD and a blue phase test cell.

FIG. 6 shows the response time of a PBP LCD.

FIG. 7A shows voltage versus transmittance of a PBP mode which is driven using an impulsive method.

FIG. 7B shows an exaggerated graph of the dotted circle area in FIG. 7A.

FIG. 7C is an exaggerated graph of the low voltage area in FIG. 7A from 0 volts to 10 volts.

FIG. 8A shows a driving scheme for impulsive driving.

FIG. 8B shows another driving scheme for impulsive driving.

FIG. 9 is an exemplary embodiment of a pixel structure of the invention.

FIGS. 10A through 10L show exemplary embodiments of pixel electrode structures of the invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower” and “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

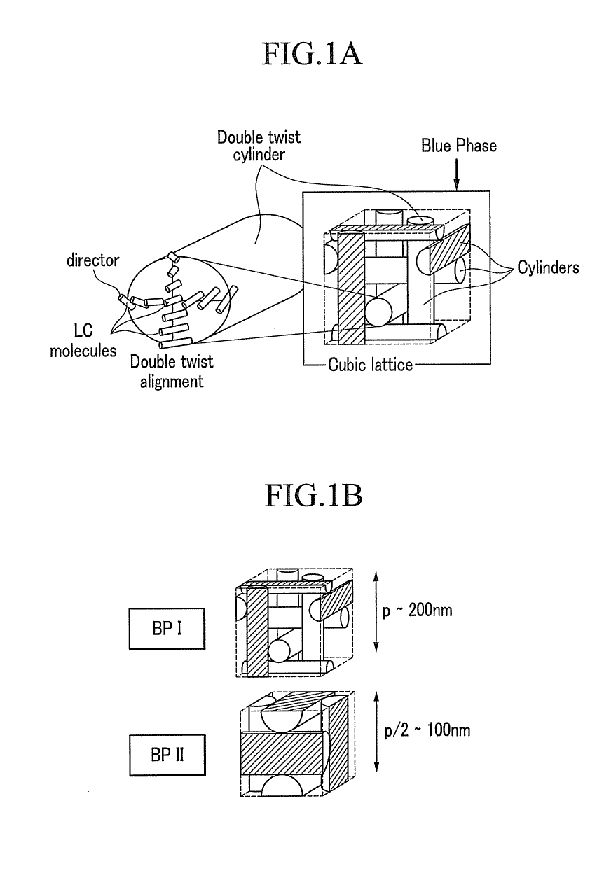

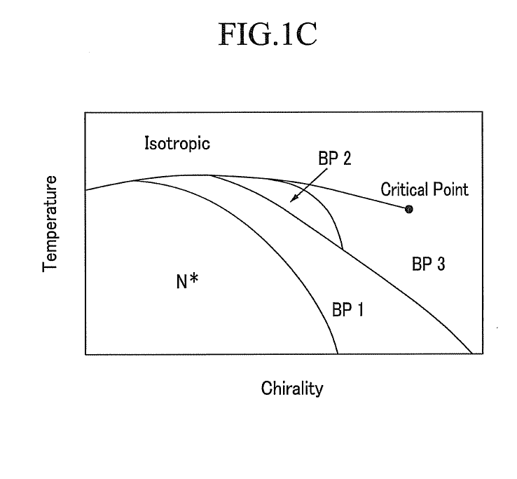

FIG. 1A shows a blue phase LC structure. The blue phase LC structure is made up of cubic lattice structures one of which is shown in the square of FIG. 1A. A unit of the cubic lattice structure is formed with a plurality of cylindrical structures. And each cylindrical structure is composed of twisted LC molecules. The cylindrical structure is called a double twist cylinder.

There are several kinds of blue phase structures. FIG. 1B shows a blue phase I (BP I) structure and a blue phase II (BP II) structure. The BP I has a body centered cubic (BCC) lattice structure and the BP II has a simple cubic lattice structure.

FIG. 1C shows the dependency of the molecule structure of a chiral nematic LC on temperature and the chirality of the LC. The horizontal axis is chirality. LC molecules having high chirality tend to be blue phase and LC molecules having low chirality tend to be nematic phase. The vertical axis is temperature. An LC molecule's structure at high temperature tends to be isotropic and an LC molecule's structure at low temperature tends to be nematic. Three kinds of blue phase structures are shown, namely BP 1 (or BP 1), BP 2 (or BP II), and BP 3 (or BP III). The higher chirality LC has a wider blue phase temperature range. If the chirality of an LC is adequate, then the LC shows blue phase at room temperature. But the LC materials available in the market these days do not have blue phase structure at room temperature. They have chiral nematic or cholesteric structure at room temperature.

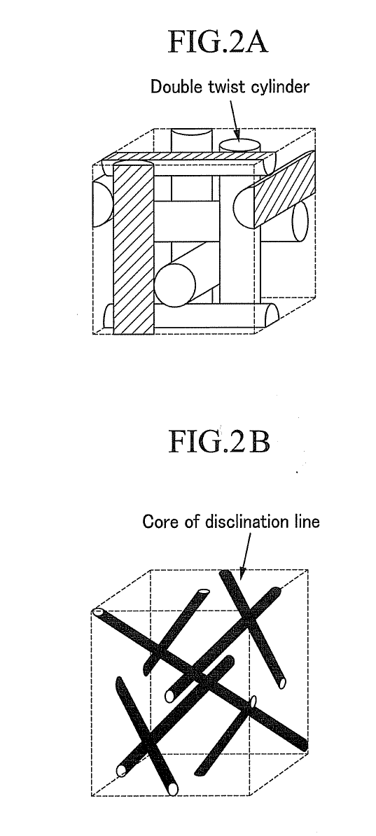

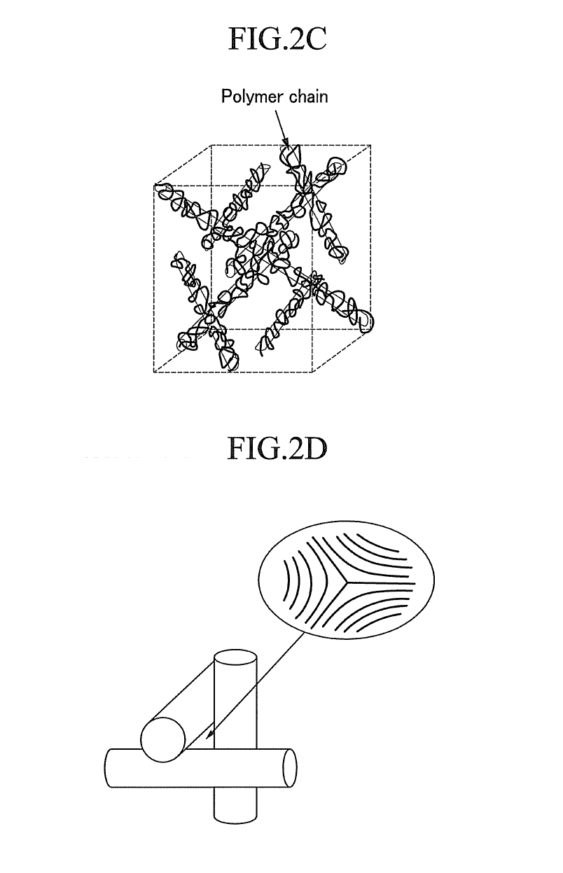

FIG. 2A shows a way to hold a blue phase structure at room temperature. One example of this is to disperse a material which is polymerized by light into the LC material. After the LC material is injected to an LC panel, the LC material is heated to a temperature showing a blue phase structure. And then the LC material is exposed to an appropriate light. FIG. 2D shows a weak area in the blue phase LC material. When the double twist cylinders are arranged with a simple cubic lattice or BCC lattice structure, there are weak areas among the cylinders and the molecules are arranged in a destabilized state. The weak areas make disclination lines in the material as shown in the center of FIG. 2A which shows the cores of disclination lines. When a foreign material is dispersed to the blue phase LC, the foreign material goes into the disclination line areas because the foreign material can easily penetrate the weak area. When the LC material in an LC panel is exposed to an appropriate light, the dispersed material is photo polymerized. Because the weak areas are easily penetrated, the dispersed material forms a polymer chain in the weak area which is shown in FIG. 2C. The polymer chain forms a frame so that the polymer chain may hold the blue phase structure even when the LC material cools down to room temperature.

A blue phase mode display (BMD) which has a blue phase LC layer in it, responds fast to an electric field change and shows high quality images in a wide range of viewing angles.

In a blue phase structure, it is optically isotropic. When an appropriate electric field is applied to the blue phase LC, the molecules are arranged parallel to or perpendicular to the electric field direction according to the dielectric anisotropy of the molecules

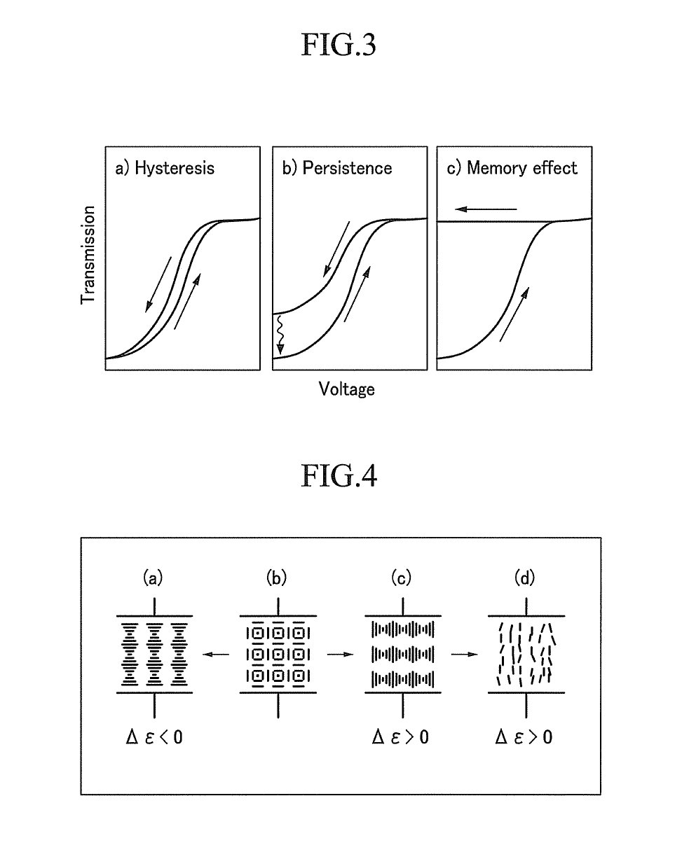

FIG. 3 shows several kinds of transmittance hysteresis curves with respect to applied voltages to LC cells. FIG. 3a) shows a voltage v. transmittance curve of a typical hysteresis whose transmittance curve depends on the history of the applied voltage. And the curve makes basically a loop whose final coordinate values are substantially the same as its initial coordinate values of the graph. FIG. 3c) shows a transmittance curve which maintains a particular state once the curve reaches the particular state. This phenomenon is called memory effect. FIG. 3b) shows a curve which shows a partial hysteresis and a partial memory effect. This phenomenon is called persistence.

FIG. 4 shows the dependency of the LC structure on the applied voltage to a blue phase mode LC cell. When an electric field is not applied to the LC cell, the LC shows the basic structure of the blue phase. This is shown in (b). When a weak electric field is applied to the LC cell, the LC cell forms a chiral nematic structure. This is shown in (a) and (c). The LC molecules in FIG. 4(a) have a negative dielectric anisotropy and the LC molecules in FIG. 4(c) have a positive dielectric anisotropy. When a strong electric field is applied to the LC cell, the LC cell forms a nematic structure as shown in FIG. 4(d). The LC molecules in FIG. 4(d) have a positive dielectric anisotropy. Negative dielectric anisotropic LC molecules form a similar structure to FIG. 4(d) when a strong electric field is applied to the LC cell. The voltage depends on the LC material and the structure of the LC cell.

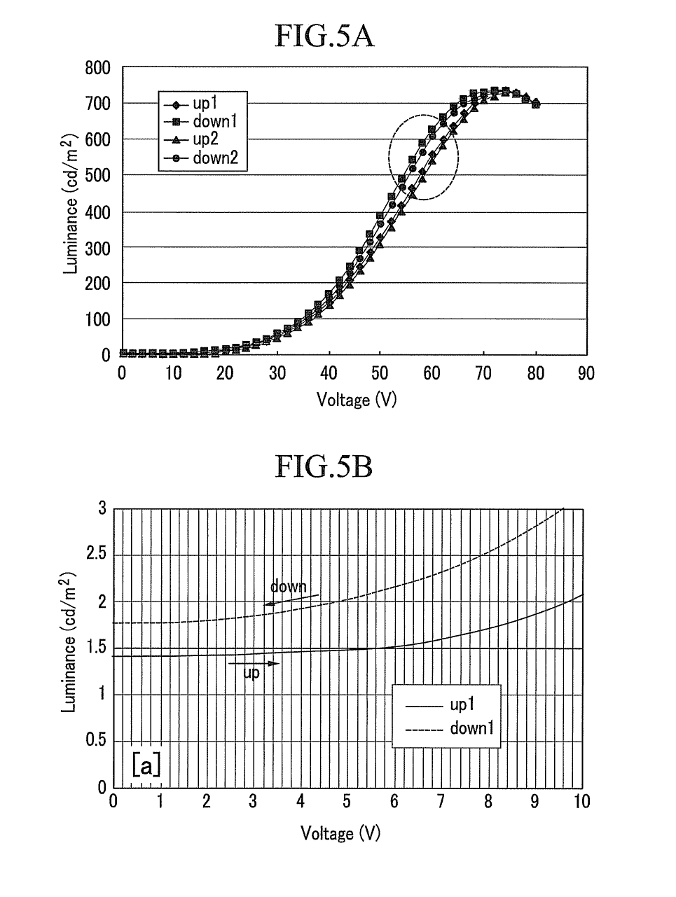

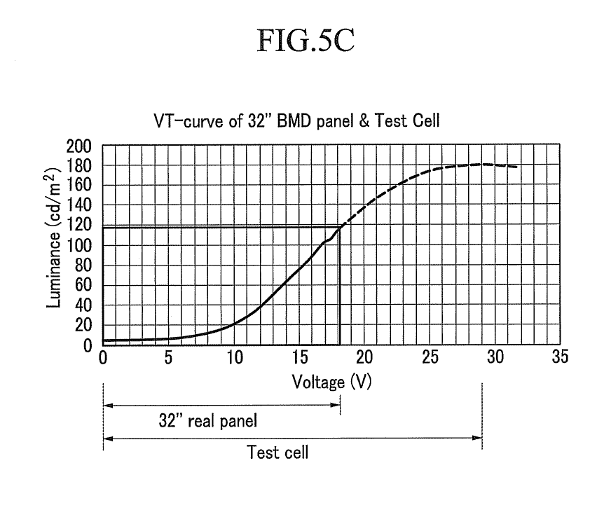

FIG. 5A shows voltage v. transmittance curves of a polymer stabilized blue phase (PBP) mode. Voltage is applied from 0 to 80 volts (upward) and then from 80 to 0 volt (downward). The voltage gap in the dotted area between the upward curve and downward curve which transmits the same ratio of light is about 4˜5 volts when the applied voltage is about 60 volts.

FIG. 5B is a blown up view of the low voltage area in FIG. 5A and shows brighter luminance when an electric field is applied for a period of time. This curve looks like the persistence model of FIG. 3. This may degrade the image quality of an LCD because an adequate return to the black state may not be achieved. This may degrade contrast ratio of an LCD. A PBP cell that shows persistence after electric field application can be corrected by using heat. Once the electrically stressed cell is heated so that the LC layer goes to an isotropic state and then the cell is cooled down to room temperature, the cell shows the same transmittance as the state that the cell in when it was not stressed by the electric field. The persistence of the PBP cell is supposed to come from the polymer of the PBP mode. The polymer may tend to hold the LC molecules to their previous orientation.

An impulsive driving method may improve the persistence of the PBP. Impulsive driving is a method to display images in a portion of time during a frame time. In an LCD, a black or gray image is applied during the remainder of the frame time. In other words, a display device will display a real image and a gray or black image alternately. In fact, the real image is not displayed on the whole screen at the same time. The real image is scanned sequentially so that a part of the real image and a part of the gray or black image may be displayed at a certain time. The gray or black signal may be called a “dummy signal”. In a pixel, a real image signal and a black or gray signal will be displayed alternatively. In this case, the LC molecules will be rearranged to display real images and black or gray images alternatively. This means the LC molecules are not held in a certain orientation but move to a black (or gray) state and some other orientation (real image state) continuously. This may help removing the persistence.

In the future, someone may find a material which shows a blue phase at room temperature and possibly commercialize that material. The impulsive driving method may be also helpful to the blue phase to improve the persistence.

FIG. 5A shows that the PBP cell transmits light maximally at about 70V. This may mean that the PBP mode should be driven with 70V to get a brighter image which consumes much energy. One embodiment of an LC cell structure is explained below and FIG. 5C shows the result. As show in FIG. 5C, electro optical characteristics of a test cell were measured. The test cell transmitted light maximally at about 26V. A voltage v. luminance curve of a 32″ real display with PBP mode is shown in a small square on the left of FIG. 5C. Because the common driving IC (integrated circuit) for an LCD can provide about 18V maximally, we measured the luminance up to 18V. The result coincides well between the test cell result and the real display result. The driving voltage for the PBP mode will be lowered by developing cell structure and LC material.

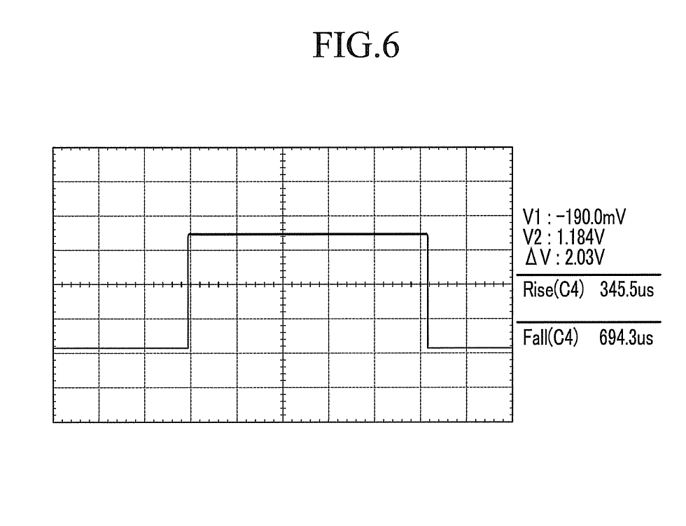

To implement an impulsive driving method, the response time of molecules should be fast enough. The response times of all commercialized LCDs are similar to or longer than the frame period which is about 16.7 ms for a 60 Hz driving method and about 8 ms for a 120 Hz driving method. FIG. 6 shows the response time of a PBP LCD. The rising time is about 0.35 ms and the falling is about 0.7 ms. Because the LC molecules move fast, PBP is good for impulsive driving. The molecules switch fully from real image orientations to black or gray image orientation and vice versa opposed to other modes of LCDs like VA mode or IPS mode.

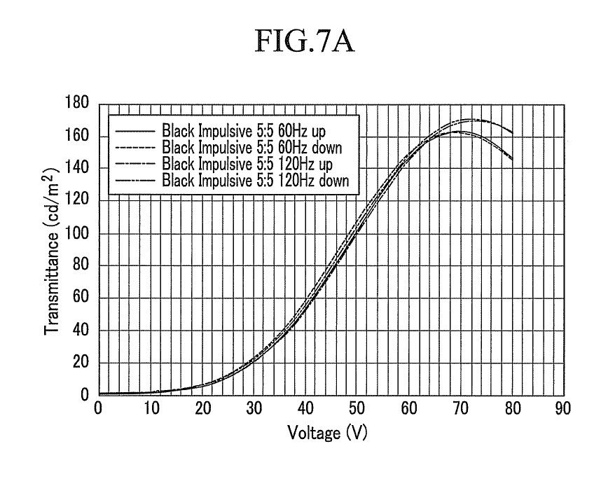

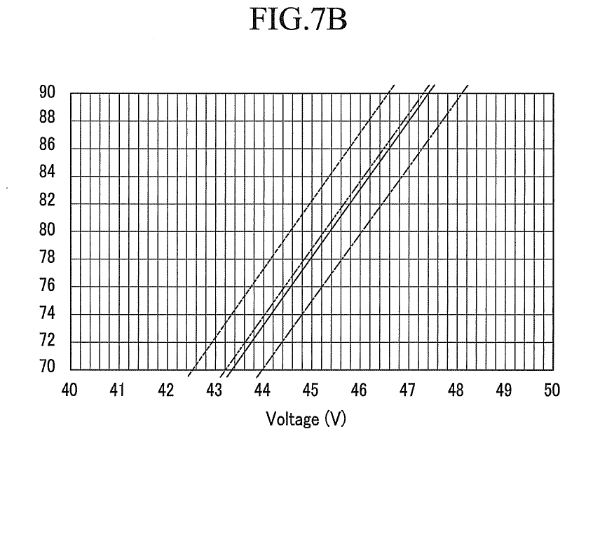

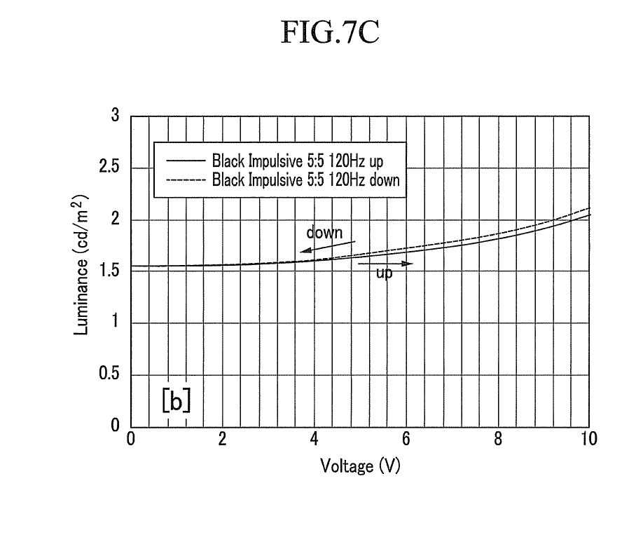

FIG. 7A shows voltage versus transmittance of a PBP mode which is driven by an impulsive method and FIG. 7B shows a blown up graph of the circled area in FIG. 7A. The maximum voltage difference is about 0.4˜0.5 volts when the applied voltage is about 45 volts. In this case, the duty ratio is half and half and the image frame frequency is 60 Hz which means that the image data and black data are applied 60 times respectively per second. Not only the black insertion but also a certain gray signal insertion improves the persistence.

FIG. 7C is a blown up graph of the black area in FIG. 7A. This area ranges from 0 volts to 10 volts. And no persistence effect is shown at the black area. If we increase the image duty ratio, then we can get brighter images. The image duty may be up to 20 times the black or gray duty.

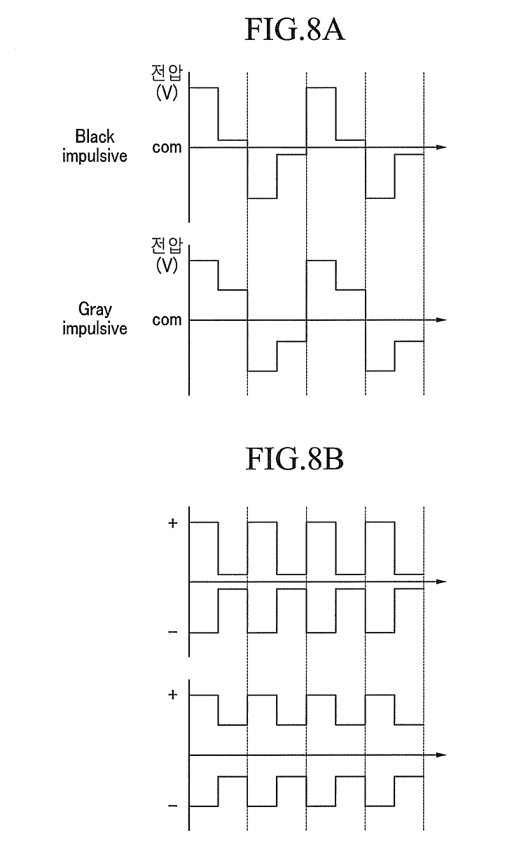

FIG. 8A shows a driving scheme for impulsive driving. In a first frame, image data is applied to a pixel electrode for a predetermined period of time and gray or black data is applied to the pixel electrode for the remainder period of the frame time. The sequence may be the reverse so that the black or gray data may be applied to the pixel for a predetermined period of time at first and then the image data may be applied for the remainder period of the frame time. The voltages may be inversed with respect to the common voltage in the next frame time as seen in FIG. 8A. If a voltage of the data signal or the black or gray signal applied in one frame time has a positive polarity with respect to the common voltage, then the voltage of those in the next frame time may have a negative polarity with respect to the common voltage. The image signal may have the same polarity to the black or gray signal with respect to the common voltage in a frame. The image signal may have the opposite polarity to the black or gray signal with respect to the common voltage in a frame. The black signal may not be the same as the common voltage.

The upper graph of FIG. 8A shows black level impulsive driving. The black levels of the positive polarity and the negative polarity may be substantially the same voltage. The black levels of the positive and negative polarities may be different from each other. The lower graph of FIG. 8A shows gray level impulsive driving.

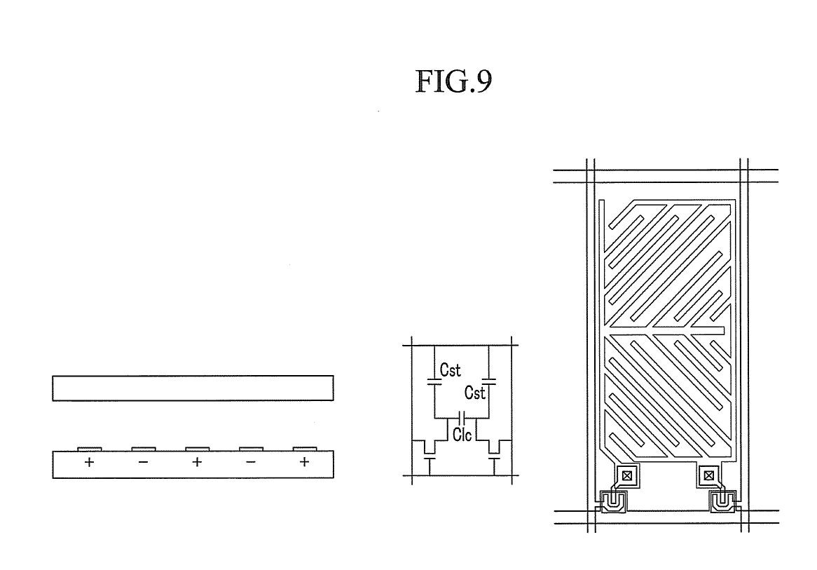

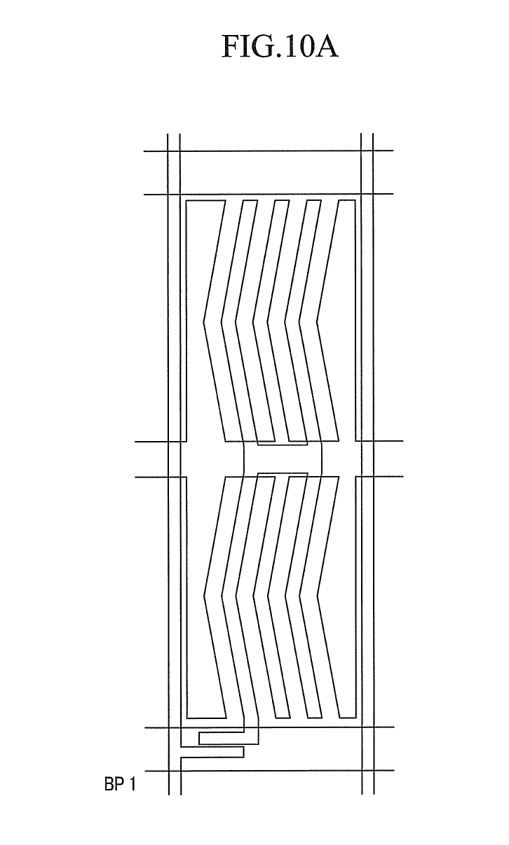

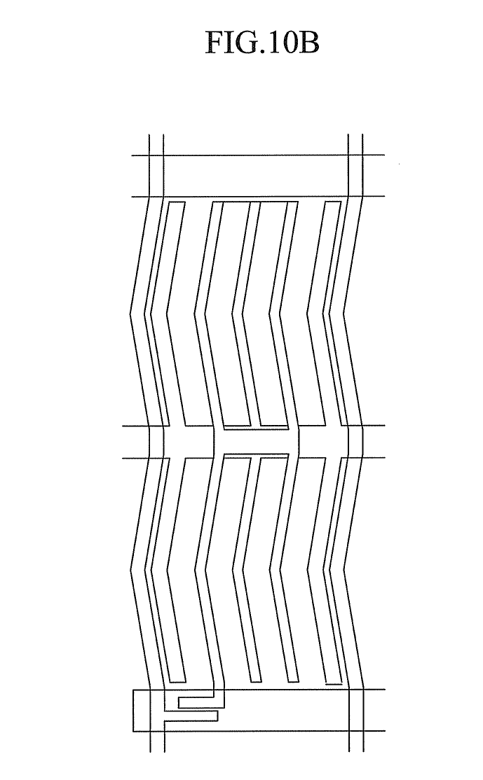

FIG. 8B shows another driving scheme for impulsive driving. There is no common voltage in this case and an LCD may not need a common electrode. The LCD may need two pixel electrodes per pixel and two switching elements per pixel. An exemplary embodiment of this structure is shown in FIG. 9. Basically, the two pixel electrodes are supplied with different voltages from each other. The higher voltage is applied to one pixel electrode and the lower voltage is applied to the other pixel electrode of the pixel. The difference between the higher voltage and the lower voltage shall be applied to the LC layer of the PBP LCD. In some cases, the two voltages may have the same level of voltages as in the black state in a normally black mode.

The upper graph of FIG. 8B shows black level impulsive driving which is at first applied to a higher image data to a first pixel electrode and a lower image data to a second pixel electrode in a pixel. And then, a higher black data is applied to the first pixel electrode and a lower black data is applied to the second pixel electrode. The higher and the lower black data may be the same voltage. Both image data and both black data may be applied in the same frame time. The polarity of the image data voltages and/or the polarity of the black data voltage applied between the first and second pixel electrodes may be switched alternately frame by frame. Even in one frame time the polarities may be switched between the black data voltages and the image data voltages. In other words, if the data voltage of the first pixel electrode is higher than the data voltage of the second pixel electrode, then the black voltage of the first pixel electrode may be lower than the black voltage of the second pixel electrode in a frame time.

The lower graph of FIG. 8B shows gray level impulsive driving. The only difference between FIG. 8B and FIG. 8A is the gray voltage. The black voltage of FIG. 8A is substituted by the gray voltage. All other driving methods may be the same as black level impulsive driving.

FIG. 9 shows an embodiment illustrating a pixel layout to implement the driving method of FIG. 8A and FIG. 8B. The pixel has two pixel electrodes and two switching elements which are connected to each pixel electrode. The switching elements are thin film transistors in FIG. 9. Two different voltages are applied to each pixel electrode. Because two different voltages are applied to each pixel electrode, an electric field is generated between the two pixel electrodes.

A high voltage drive IC is more expensive than a low voltage drive IC. One high voltage drive IC may be more expensive than two low voltage drive ICs. The upper exemplary embodiment may be one way to implement a method using two low voltage drive ICs instead of one high voltage drive IC to reduce manufacturing cost. If a total driving voltage range of the LCD is 30 V, one drive IC may provide a video signal range from −15 V to 0 V and the other drive IC may provide another video signal range from 0 V to 15 V to the pixel electrodes so that the total video signal ranges from −15 V to 15 V. Another exemplary embodiment is that one drive IC may provide a video signal range from 0 V to 15 V and the other drive IC may provide a video signal range form 15 V to 30 V. In this case, the ground voltage of the former IC may be 0 V and the ground voltage of the latter IC may be 15 V. If the ground voltages of the drive ICs are different from each other, the substrates that each drive IC is mounted may be separated from each other to insulate better each other. Two circuits mounted on two separated substrates may be easier to insulate than two circuits mounted on one substrate.

Here is another embodiment to overcome the hysteresis and memory effect of blue phase LCD or PBP LCD. The brightness of a current frame time of a pixel depends on the history of the pixel. Therefore, if the history of a pixel is known, an optimum voltage of a current frame time can be predicted to get a proper brightness. One previous frame image data of a pixel may be enough to predict a proper voltage of a current frame of the pixel. Two or several previous frame image data of a pixel may be needed to predict a proper voltage of a current frame of the pixel. The image data of previous frames maybe stored in a memory. By comparing the previous image data and current image data of a pixel, we can predict the current voltage that should be applied to the pixel at a current frame time. We may need a look up table (LUT) that shows the relationship between image data and real voltage that should be applied to the pixel electrode at a current frame time.

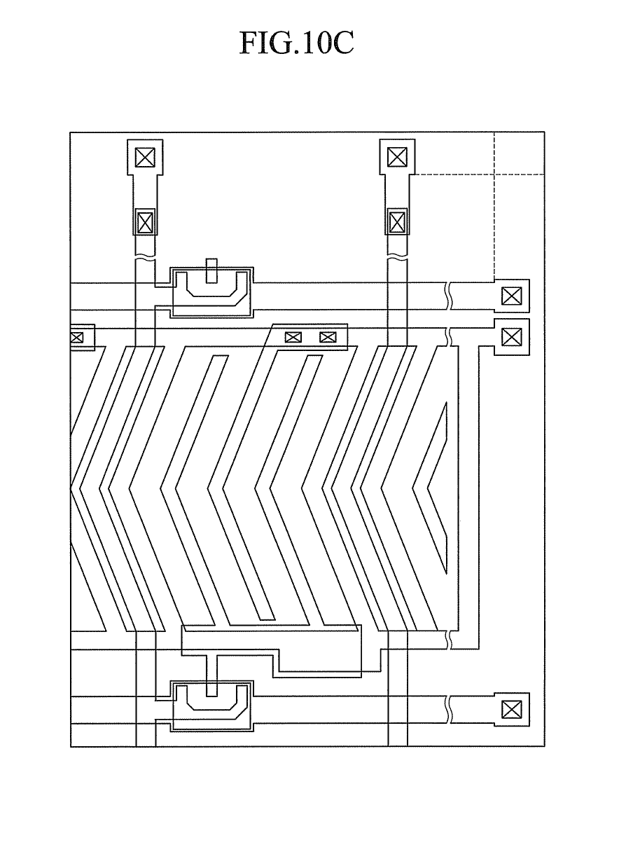

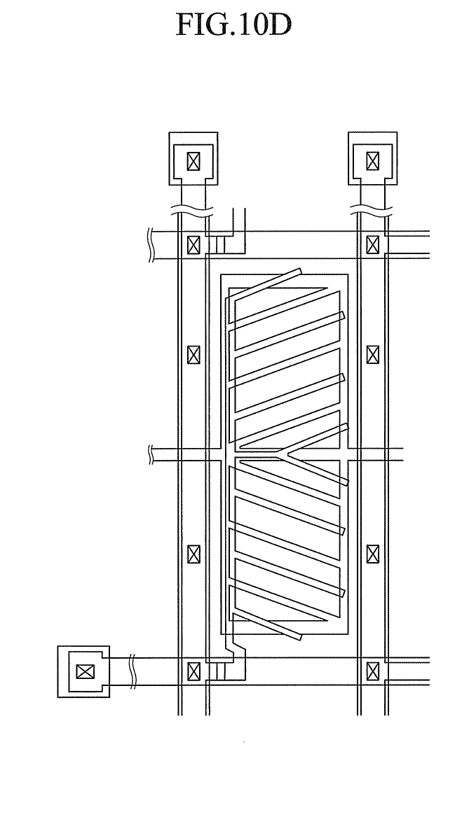

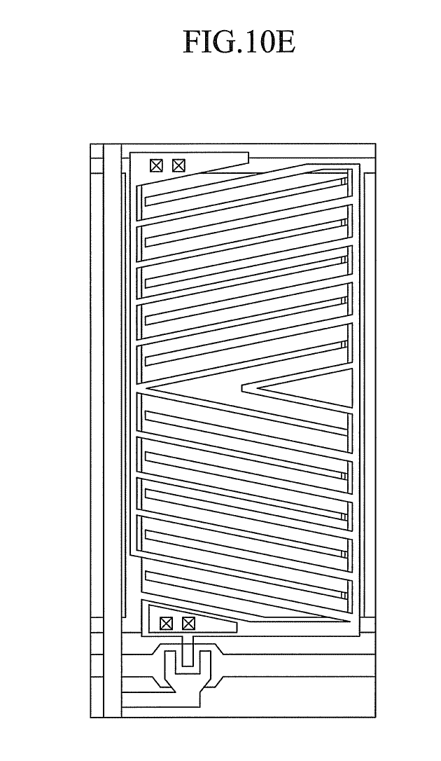

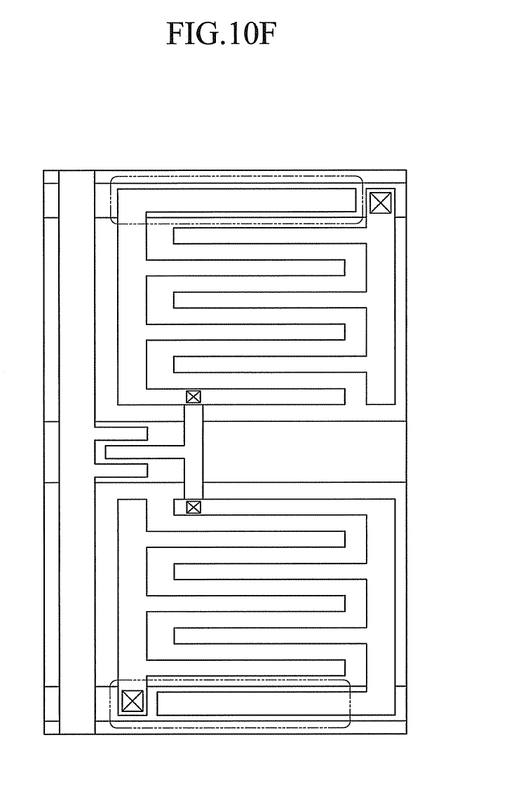

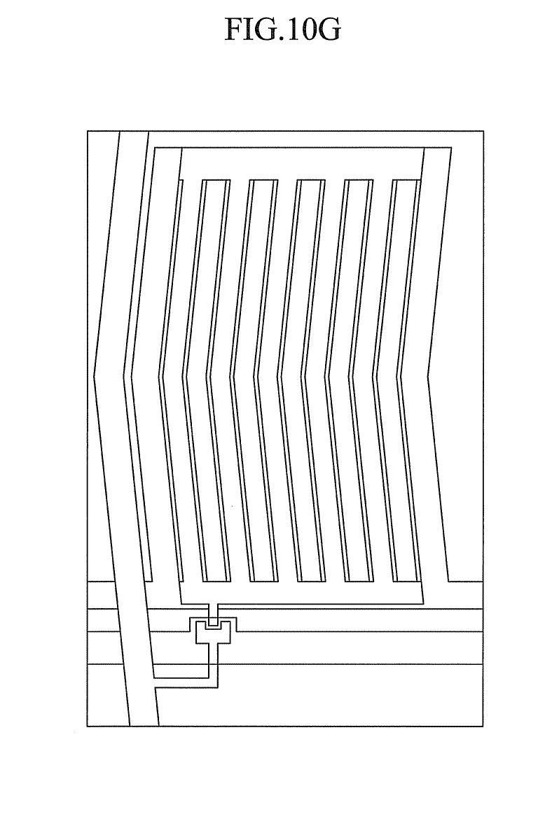

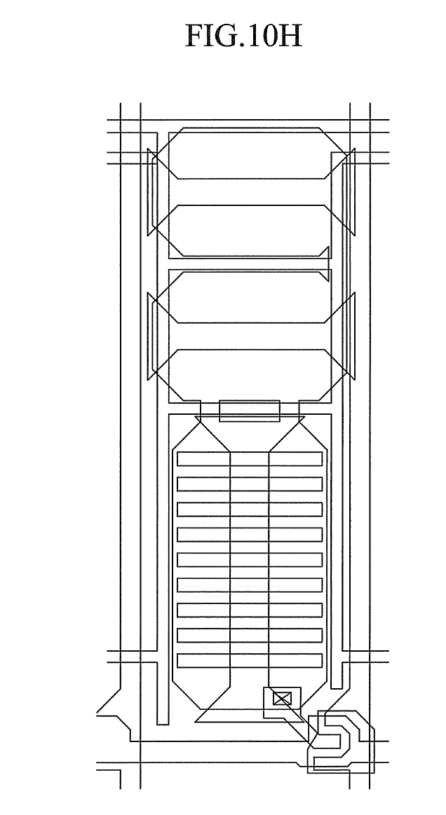

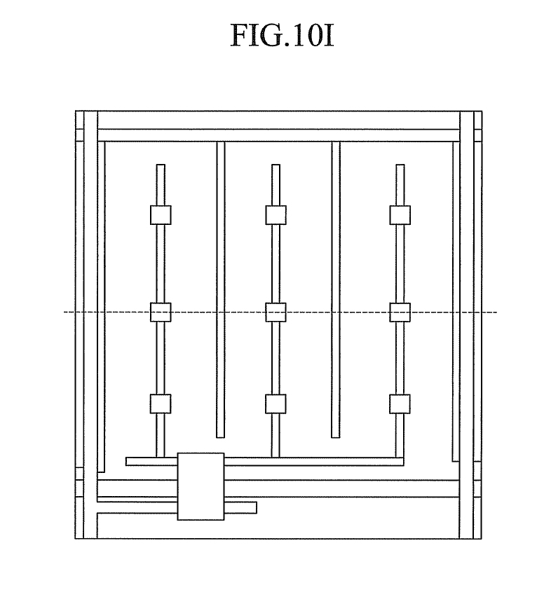

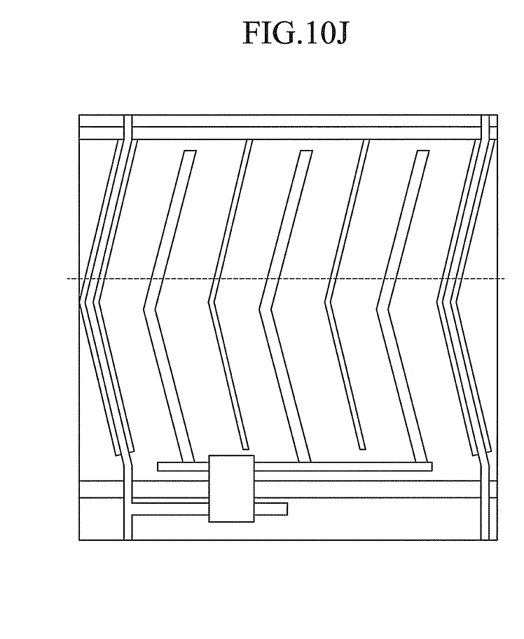

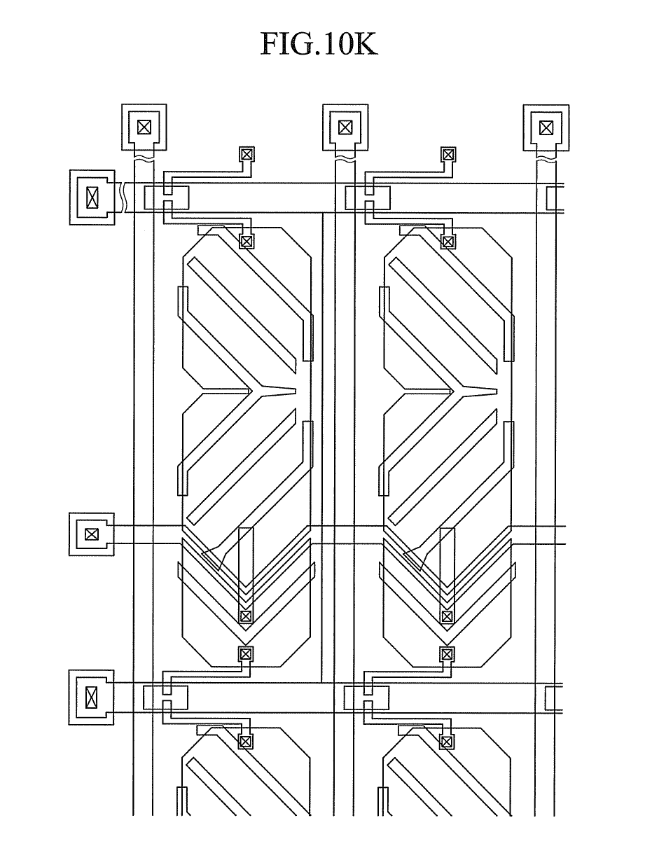

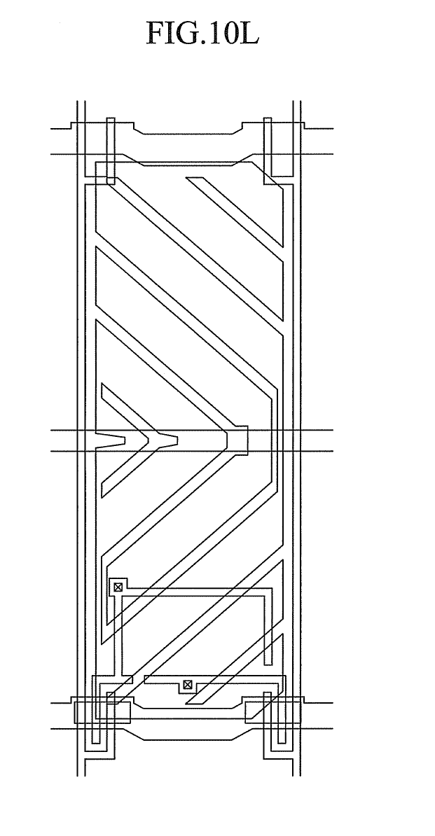

Many kinds of pixel electrode structures may be applicable to the blue phase mode LCD and PBP mode LCD. The pixel electrode structures for twisted nematic (TN) mode, patterned vertical alignment (PVA) mode, in plane switching (IPS) mode, multi domain vertical alignment (MVA) mode, plane to line switching (PLS) mode, fringe field switching (FFS) mode or the derivatives of those may be used to apply an electric field to a blue phase LC layer or PBP LC layer. Here are some examples of the pixel structure in FIG. 10A, FIG. 10B, FIG. 10C, FIG. 10D, FIG. 10E, FIG. 10F, FIG. 10G, FIG. 10H, FIG. 10I, FIG. 10J, FIG. 10K, and FIG. 10L. The effect of electric field of each pixel electrode and the manufacturing method of the LCD are described in the US patent application publications 2007/0153198, 2007/0153199, 2007/0159586, 2007/0242206, 2008/0002127, 2008/0018844, 2008/0024688, 2008/0036933, 2008/0042956, 2008/0285589, and the technically related patents of these which contents are incorporated by reference herein.

Blue phase or PBP mode LCDs are optically isotropic when an electric field is not applied. Therefore laying the LC molecules down to be parallel to the surface of the substrate may be helpful to get a high contrast ratio LCD. When a vertical alignment (VA) mode category pixel electrode is adopted for an LCD, a negative dielectric anisotropic LC material may be better to get a high contrast ratio LCD. The VA mode category may be PVA mode or MVA mode. In this case, the LC molecules may be laid out in a predetermined direction using a fringe field or other means so that a bunch of molecules can operate in an optically effective matter.

Positive dielectric anisotropic LC material is aligned to an electric field, so that the pixel electrodes for IPS mode, PLS mode or FFS mode may be good to control the blue phase mode LC or PBP mode LC.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display comprising,
a first substrate which has pixel electrodes,
a second substrate opposite the first substrate,
an LC layer disposed between the first substrate and the second substrate, the LC layer comprising LC molecules and a polymer structure which stabilizes the LC molecules to the arrangement that the liquid crystal molecules are arranged at a temperature of about 1 degree C. below the transition temperature from the isotropic phase of the liquid crystal, and
a circuitry which transfers image signals and dummy signals to the pixel electrodes, wherein the dummy signals are applied to the pixel electrodes, and the dummy signals are black signals or gray signals.

2. The liquid crystal display of claim 1, wherein the image signals and the dummy signals are alternately applied to the pixel electrodes.

3. The liquid crystal display of claim 2, wherein the term applying the image signals to the pixels is longer than the term applying the dummy signals to the pixels.

4. The liquid crystal display of claim 2, wherein the ratio of the dummy signal applying time to the image signal applying time is less than 50%.

5. The liquid crystal display of claim 2, wherein the dummy signal applying time is less than 5 ms.

6. The liquid crystal display of claim 1, wherein the pixel electrode is trident shape.

7. The liquid crystal display of claim 1, wherein the pixel electrodes are similar to the pixel electrodes of IPS mode, PVA mode, MVA mode, PLS mode, or FFS mode.

8. The liquid crystal display of claim 7, wherein the LC has positive dielectric anisotropy when the pixel electrodes are similar to the pixel electrodes of IPS mode, PLS mode, or FFS mode.

9. The liquid crystal display of claim 7, wherein the LC has negative dielectric anisotropy when the pixel electrodes are similar to the pixel electrodes of PVA mode or MVA mode.

10. The liquid crystal display of claim 1, wherein each of the pixel electrodes belong to a pixel, and a pixel comprises two or more pixel electrodes.

11. A liquid crystal display comprising,
a first substrate which has pixel electrodes,
a second substrate opposite the first substrate,
an LC layer disposed between the first substrate and the second substrate, the LC layer being a blue phase or a polymer stabilized blue phase, and
a circuitry which transfers impulsive image signals to the pixel electrodes.

12. The liquid crystal display of claim 11, wherein the impulsive image signals comprises dummy signals and image signal.

13. The liquid crystal display of claim 12, wherein the image signals and the dummy signals are applied to a pixel electrode alternately.

14. The liquid crystal display of claim 13, wherein the term applying the image signals to the pixel is longer than the term applying the dummy signals to the pixel.

15. The liquid crystal display of claim 13, wherein the ratio of the dummy signal applying time to the image signal applying time is less than 50%.

16. The liquid crystal display of claim 13, wherein the dummy signal applying time is less than 5 ms.

17. A manufacturing method of a blue phase mode LCD, comprising:
forming an liquid crystal panel comprising two substrates opposing each other and a liquid crystal layer disposed between the two substrate, and
exposing the liquid crystal panel to an electro magnetic wave so that a material in the liquid crystal layer is photo polymerized.

18. The manufacturing method of claim 17, further comprising:
forming a pixel electrode on a surface of the two substrates, wherein the pixel electrode is trident shape.

19. The manufacturing method of claim 17, further comprising:
forming a pixel electrode on a surface of the two substrates and the pixel electrode is similar to the pixel electrode of IPS mode, PVA mode, MVA mode, PLS mode or FFS mode.

20. The manufacturing method of claim 17, further comprising:
forming pixel electrodes on a surface of the two substrates and a pixel comprises two or more pixel electrodes.
